(19) United States
(12) Patent Application Publication
(10) Pub. No.: US 2017/0103087 A1
(43) Pub. Date: Apr. 13, 2017

(54) SUBSYSTEM DATASET UTILIZING CLOUD STORAGE

(71) Applicant: CA, Inc., New York, NY (US)

(72) Inventors: David HELSLEY, McKinney, TX (US); Lawrence LEE, McKinney, TX (US); Kenneth ELLINGTON, Carrollton, TX (US)

(73) Assignee: CA, Inc.

(21) Appl. No.: 14/881,560

(22) Filed: Oct. 13, 2015

(51) Int. Cl. G06F 17/30

(52) U.S. Cl. CPC G06F 17/30185; G06F 17/30082; G06F 17/30578

(57) ABSTRACT

A method is described for detecting a mainframe dataset on a local storage medium managed by a mainframe operating system, the mainframe dataset comprising a plurality of related files. According to a storage policy, a first subset of the plurality of related files to store on a cloud storage medium is determined. A second subset of the plurality of related files to remain on the local storage medium is also determined. The first subset of the plurality of related files is written to the cloud storage system, according to the storage policy. An input operation for the mainframe dataset is detected via a component of the mainframe operating system. Finally, an update of the first subset of the plurality of related files on the local storage medium is emulated on the cloud storage medium.

### BACKGROUND

The present disclosure relates to interfaces and, in particular, to a system, a computer program product, and method for determining, via a storage policy, a subset of related files to store on a cloud storage medium.

### SUMMARY

According to an embodiment of the present disclosure, a method is disclosed comprising detecting a mainframe dataset on a local storage medium managed by a mainframe operating system, the mainframe dataset comprising a plurality of related files. The method further comprising determining, based on a storage policy, a first subset of the plurality of related files to store on a cloud storage medium and a second subset of the plurality of related files to remain on the local storage medium. The method further comprising writing, according to the storage policy, the first subset of the plurality of related files to the cloud storage system, and detecting, via a component of the mainframe operating system, an input operation for the mainframe dataset. The method further comprising emulating an update, defined by the input operation, of the first subset of the plurality of related files on the local storage medium to the cloud storage medium.

According to another embodiment of the present disclosure, a processing system configured to perform the aforementioned method.

According to another embodiment of the present disclosure, a computer program product comprising a computer-readable storage medium having computer-readable program code embodied therewith, the computer-readable program comprising computer-readable program code configured to perform the aforementioned method.

Other objects, features, and advantages will be apparent to persons of ordinary skill in the art in view of the following detailed description and the accompanying drawings.

### BRIEF DESCRIPTION OF THE DRAWINGS

For a more complete understanding of the present disclosure, needs satisfied thereby, and the objects, features, and advantages thereof, reference now is made to the following description taken in connection with the accompanying drawings. Embodiments of the present disclosure, and their features and advantages, may be understood by referring to FIGS. 1-4, like numerals being used for corresponding parts in the various drawings.

FIG. 1 illustrates a storage ecosystem of a non-limiting embodiment of the present disclosure.

FIG. 2 illustrates interaction between a local storage medium and a cloud storage medium of a non-limiting embodiment of the present disclosure.

FIG. 3 illustrates the effect of an input operation on a local storage medium and a cloud storage medium of a non-limiting embodiment of the present disclosure.

FIG. 4 illustrates a flow diagram depicting a policy driven storage process in a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADED, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

Current mainframe clients utilize proprietary disk and tape methods for storing information. Tape storage provides high-capacity storage at relatively low cost at an enterprise level. However, tape storage presents its own set of challenges. Tape storage is generally not granular enough to back up individual files or to journal changes to files offsite. As a result, disaster backup and recovery is difficult to accomplish with a tape medium. In addition, some operating systems such as, for example, z/OS, utilize a proprietary data writing method called extended count key data (ECKD) to write to a disk. However, writing to a disk using this method is cost prohibitive as there are a limited number of vendors that can perform such a service.

Accordingly, there is a need in the marketplace for a storage system that exploits other storage mediums to compensate for the deficiencies of tape storage. The present disclosure provides, inter alia, a cloud storage medium for storing mainframe datasets. The present disclosure describes, inter alia, storing all local data in the cloud such that read and write operations actually retrieve and send data to the cloud, rendering a local copy unnecessary. Furthermore, the current disclosure provides a complementary to current storage methods, wherein updates may be journaled to the cloud and local file copies may be retained. This unique solution may be extended to applications, databases, storage, etc. Embodiments of the present disclosure may address the above problems, and other problems, individually and collectively.

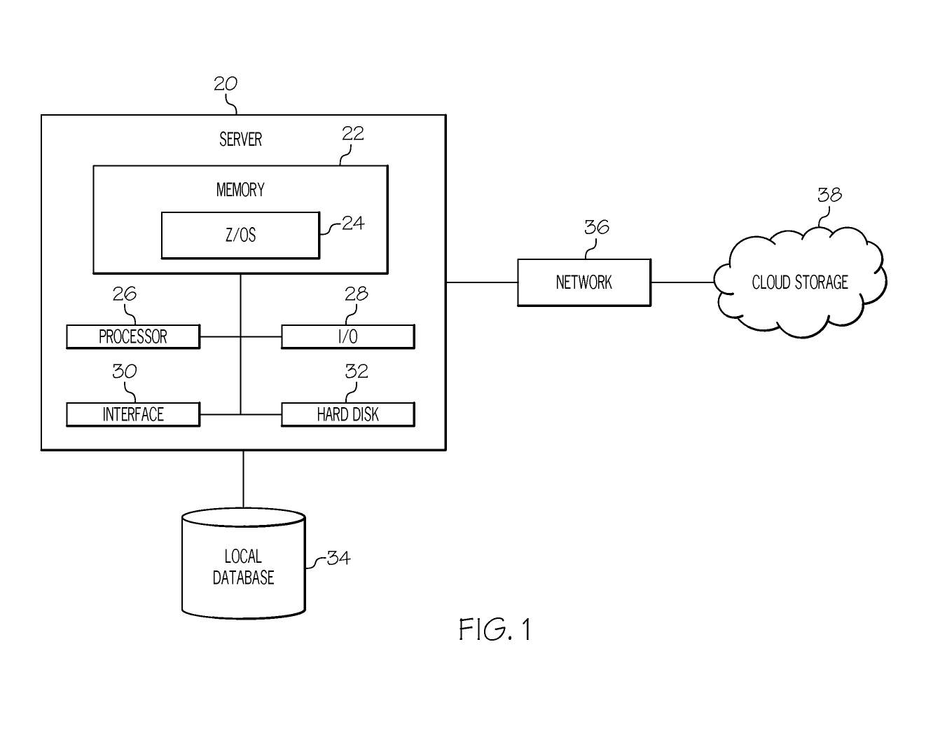

FIG. 1 illustrates a storage ecosystem of a non-limiting embodiment of the present disclosure. The storage ecosystem may include a server 20, a memory 22, an operating system 24 (e.g., z/OS), a processor 26, an interface 30, an input and output (“I/O”) device 28, and a hard disk 32. Operating system 24 analyses may take place on the server 20 shown in FIG. 1. Processor 26 may be operable to load instructions from hard disk 32 into memory 22 and execute those instructions. Memory 22 may store computer-readable instructions that may instruct the server 20 to perform certain processes. I/O device 28 may receive one or more of data from another server, local database 34, or a network 36. The server 20 may be considered a processing system. Furthermore, operating system 24 may perform analysis on any processing system, wherein the processing system comprises one or more processors.

Network 36 may comprise one or more entities, which may be public, private, or community based. Network 36 may permit the exchange of information and services among users/entities that are connected to such network 36. In certain configurations, network 36 may be a local area network, such as an intranet. Further, network 36 may be a closed private network/cloud in certain configurations and an open network/cloud in other configurations. Network 36 may facilitate wired or wireless communications of information and provisioning of services among users that are connected to network 36.

The fault isolation ecosystem may also include a local database 34 which may include, for example, additional servers, data storage, and resources. Operating system 24 may receive additional data from local database 34. Operating system 24 may also store system performance, system analysis, and any information regarding server or network management on the local database 34. Operating system 24 may also store information regarding system file read and write operations, as well as any data regarding transferring information external to the server 20.

Operating system 24 analyses may include examination of storage capabilities of local database 34. Additionally, operating system 24 may analyze past and current performance of network elements, including local database 34. Furthermore, operating system 24 may examine storage capabilities of cloud storage 38 via network 36. Operating system 24 may also determine which storage medium is best for a certain type of data or for metadata of a certain characteristic.

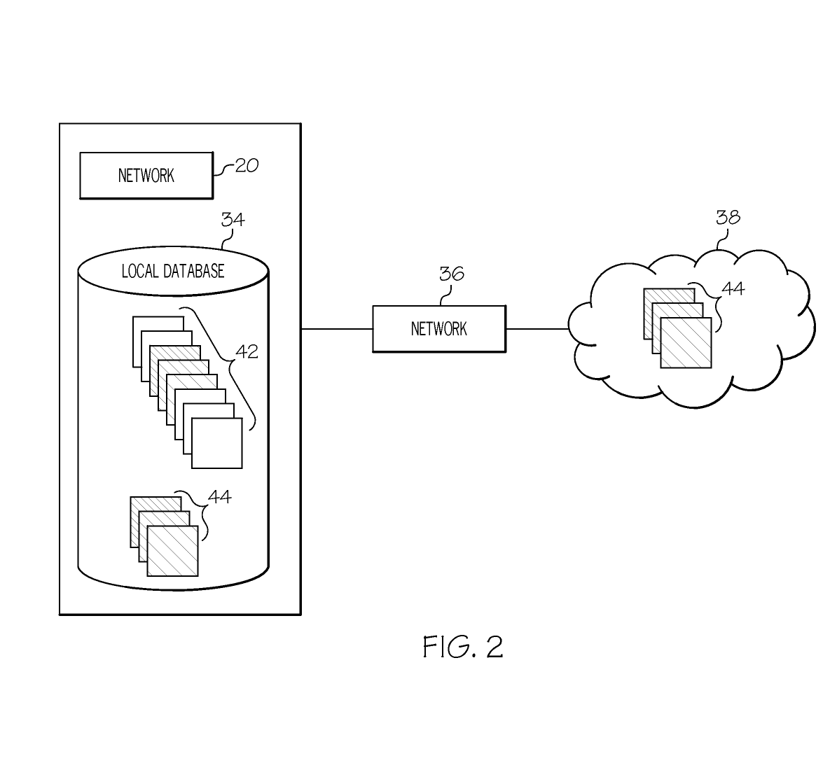

FIG. 2 illustrates interaction between a local storage medium and a cloud storage medium of a non-limiting embodiment of the present disclosure. Operating system 24 on server 20 may detect a mainframe dataset 42 on a local storage medium such as a local database 34. The local storage medium may be, for example, a tape drive, a disk drive, any other medium supported by the mainframe computer system, or any combination thereof. The mainframe dataset 42 may include a plurality of related files. Administrator of the server 20 may implement a storage policy to direct the operating system 24. The storage policy may determine the storage location of any data within the storage ecosystem. For example, the storage policy may determine a first subset of a plurality of related files to store on a cloud storage medium and a second subset of the plurality of related files to remain on the local storage medium. Cloud storage 38 may be used for storing mainframe datasets of any kind of access methods including, for example, virtual sequential access method (VSAM) filed, queued sequential access method (QSAM) files, and basic sequential access method (BSAM) files.

The storage policy may determine that all files on a local database 34 are to be stored on a cloud storage medium such as cloud storage 38. A user or system administrator may define a storage policy via a graphical user interface (GUI). For example, regarding z/OS, a subsystem interface component may be used to manage control points during file input/output operations. Furthermore, a storage policy may determine a cost of storage among a plurality of storage mediums, such as, for example, local and cloud storage mediums. Moreover, cost analysis may impact how files are stored in the storage ecosystem.

In addition, a storage policy may designate a type of data to store on a cloud storage medium. Moreover, the operating system 24 may schedule, according to a storage policy, the storage of the designated type of data on the cloud storage medium, or any other available storage medium. In this case, when data of the designated type is created on the local storage medium, the data may be automatically stored or written to the cloud storage medium. In some non-limiting embodiments, the data may be written to the cloud storage medium via a representational state transfer application programming interface.

As illustrated in FIG. 2, operating system 24 may implement a storage policy to select a subset 44 of a plurality of files 42. The plurality of files 42 may be related by any measure of metadata, such as, for example, size, type, storage classification, time of creation, creator, etc. The storage policy may indicate that the subset 44 should be written to cloud storage 38. FIG. 2 depicts the subset 44 of the plurality of files 42 stored on cloud storage 38 via network 36. In some non-limiting embodiments, data that is stored on the cloud storage 38 may be removed from the local storage medium. In some non-limiting embodiments, any read or write operation may retrieve and send data to the cloud storage 38.

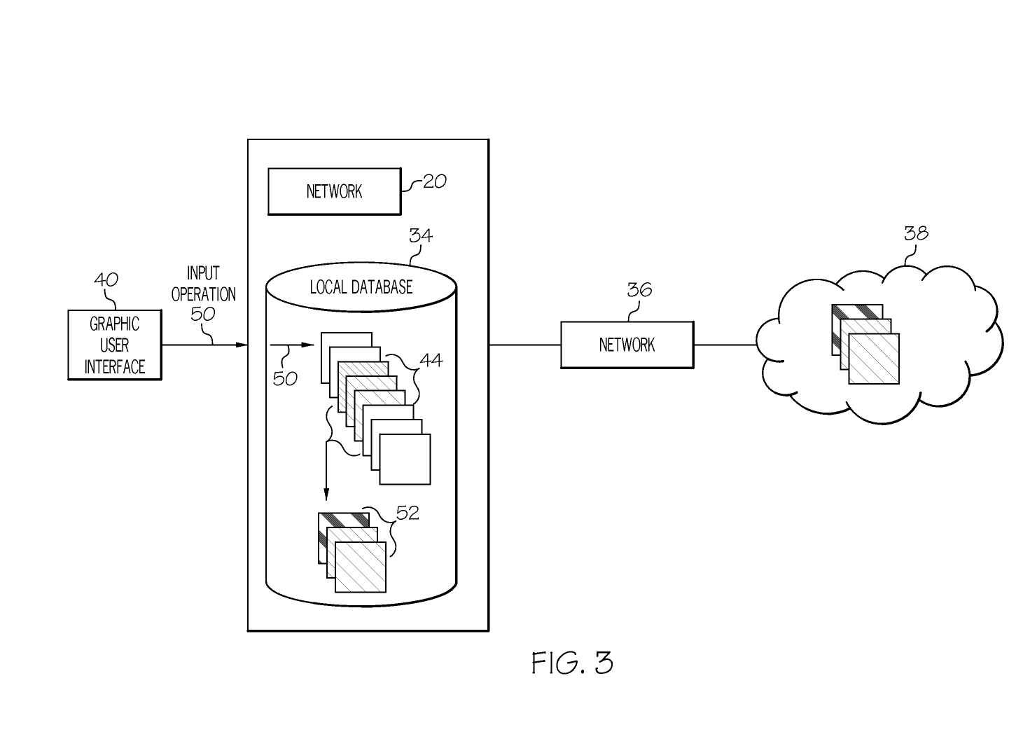

FIG. 3 illustrates the effect of an input operation on a local storage medium and a cloud storage medium of a non-limiting embodiment of the present disclosure. A system administrator may use a graphical user interface 40 to implement an input operation 50. An input operation 50 may modify any data within the local database 34. For example, the input operation 50 may update the subset 44 of the plurality of files 42 such that the subset 44 becomes a modified subset 52. This update may or may not be in accordance with a storage policy. If an implemented storage policy indicates that the modified subset 51 is to be stored on a cloud storage medium, the subset 44 on the cloud storage medium may be updated in accordance with the modification. In other words, the data on the cloud storage medium may be modified, either manually or automatically, to reflect the update to the data on the local database 34.

Updating the data on the cloud storage medium may be accomplished by asynchronous journaling between the subset of the plurality of files on the local storage medium and the cloud storage medium. In some non-limiting embodiments, this process may occur via synchronous journaling. Furthermore, instead of writing each file of the subset 44 to the cloud storage medium, the operating system 24 may instruct that only the metadata of the subset 44 of the plurality of files 42 is written to the cloud storage medium. In other words, an implemented storage policy may determine that metadata from the subset 44 of the plurality of related files 42 is to be exported to the cloud storage medium.

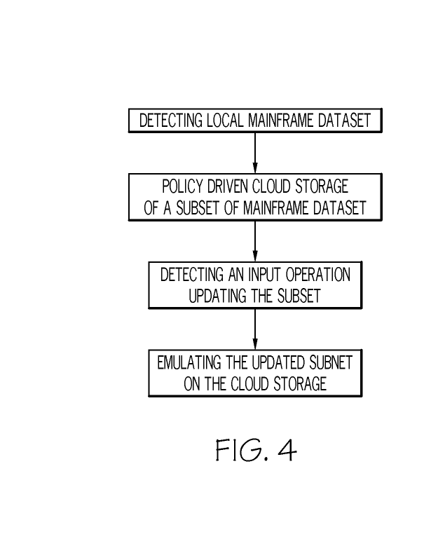

FIG. 4 illustrates a flow diagram depicting a policy driven storage process in a non-limiting embodiment of the present disclosure. In step 400, an operating system may detect a local mainframe dataset. The local mainframe dataset may comprise a plurality of files. Some, all, or none of the files may be related. In step 410, the operating system may implement a storage policy whereby a subset of the plurality of files is directed to be stored on a cloud storage medium. In step 420, the operating system may detect an input operation updating the subset of the plurality of files on the local mainframe. The input operation may be a result of an automatic update, a user-defined update (e.g., via a GUI), etc. Finally, in step 430, the operating system may emulate the updated subset on the cloud storage medium, such that the subset of the plurality of files are equivalent on both the local and cloud storage mediums.

The figures illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

While the present disclosure has been described in connection with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It will also be understood by those of ordinary skill in the art that the scope of the disclosure is not limited to use in a server diagnostic context, but rather that embodiments of the invention may be used in any transaction having a need to monitor information of any type. The specification and the described examples are considered as exemplary only, with the true scope and spirit of the invention indicated by the following claims.

What is claimed is:

1. A method, comprising:
detecting a mainframe dataset on a local storage medium managed by a mainframe operating system, the mainframe dataset comprising a plurality of related files;
determining, based on a storage policy, a first subset of the plurality of related files to store on a cloud storage medium and a second subset of the plurality of related files to remain on the local storage medium;
writing, according to the storage policy, the first subset of the plurality of related files to the cloud storage system;
detecting, via a component of the mainframe operating system, an input operation for the mainframe dataset; and
emulating an update, defined by the input operation, of the first subset of the plurality of related files on the local storage medium to the cloud storage medium.

2. The method of claim 1, wherein emulating the update, defined by the input operation, of the first subset of the plurality of related files further comprises:
asynchronous journaling between the first subset of the plurality of related files on the local storage medium and the cloud storage medium.

3. The method of claim 1, wherein emulating the update, defined by the input operation, of the first subset of the plurality of related files further comprises:
synchronous journaling between the first subset of the plurality of related files on the local storage medium and the cloud storage medium.

4. The method of claim 1, further comprising:
exporting metadata from the first subset of the plurality of related files to the cloud storage medium.

5. The method of claim 1, further comprising:
defining the storage policy via a graphical user interface.

6. The method of claim 1, wherein the local storage medium is a tape drive.

7. The method of claim 1, further comprising:
scheduling, according to the storage policy, a storage on the cloud storage medium of a designated type of data;
writing first data on the local storage medium, wherein the first data is of the designated type of data; and
writing, automatically, the first data on the cloud storage medium via a representational state transfer application programming interface.

8. The method of claim 1, wherein the storage policy further comprises:
determining a cost of storage among a plurality of storage mediums, wherein the plurality of storage mediums comprise the local storage medium and the cloud storage medium.

9. The method of claim 1, wherein determining, based on a storage policy, a first subset of the plurality of related files to store on a cloud storage medium further comprises:
determining respective metadata for each of the plurality of related files;
selecting the first subset of the plurality of related files based on a characteristic of the respective metadata.

10. The method of claim 1, further comprising:
removing the first subset of the plurality of related files on the local storage medium after writing the first subset of the plurality of related files to the cloud storage system.

11. A system comprising:
a processing system configured to perform processes comprising:
detecting a mainframe dataset on a local storage medium managed by a mainframe operating system, the mainframe dataset comprising a plurality of related files;
determining, based on a storage policy, a first subset of the plurality of related files to store on a cloud storage medium and a second subset of the plurality of related files to remain on the local storage medium;
writing, according to the storage policy, the first subset of the plurality of related files to the cloud storage system;
detecting, via a component of the mainframe operating system, an input operation for the mainframe dataset; and
emulating an update, defined by the input operation, of the first subset of the plurality of related files on the local storage medium to the cloud storage medium.

12. The system of claim 11, wherein emulating the update, defined by the input operation, of the first subset of the plurality of related files further comprises:
asynchronous journaling between the first subset of the plurality of related files on the local storage medium and the cloud storage medium.

13. The system of claim 11, wherein emulating the update, defined by the input operation, of the first subset of the plurality of related files further comprises:
synchronous journaling between the first subset of the plurality of related files on the local storage medium and the cloud storage medium.

14. The system of claim 11, further comprising:
exporting metadata from the first subset of the plurality of related files to the cloud storage medium.

15. The system of claim 11, further comprising:
defining the storage policy via a graphical user interface

16. The system of claim 11, wherein the local storage medium is a disk drive.

17. The system of claim 11, further comprising:
scheduling, according to the storage policy, a storage on the cloud storage medium of a designated type of data;
writing first data on the local storage medium, wherein the first data is of the designated type of data; and
writing, automatically, the first data on the cloud storage medium via a representational state transfer application programming interface.

18. The system of claim 11, wherein the storage policy further comprises:
determining a cost of storage among a plurality of storage mediums, wherein the plurality of storage mediums comprise the local storage medium and the cloud storage medium.

19. The system of claim 11, wherein determining, based on a storage policy, a first subset of the plurality of related files to store on a cloud storage medium further comprises:
determining respective metadata for each of the plurality of related files; selecting the first subset of the plurality of related files based on a characteristic of the respective metadata.

20. A computer program product comprising:
a computer-readable storage medium having computer-readable program code embodied therewith, the computer-readable program code comprising:
computer-readable program code configured to detect a mainframe dataset on a local storage medium managed by a mainframe operating system, the mainframe dataset comprising a plurality of related files;
computer-readable program code configured to determine, based on a storage policy, a first subset of the plurality of related files to store on a cloud storage medium and a second subset of the plurality of related files to remain on the local storage medium;
computer-readable program code configured to write, according to the storage policy, the first subset of the plurality of related files to the cloud storage system;
computer-readable program code configured to detect, via a component of the mainframe operating system, an input operation for the mainframe dataset; and
computer-readable program code configured to emulate an update, defined by the input operation, of the first subset of the plurality of related files on the local storage medium to the cloud storage medium.
